(19) United States
(12) Patent Application Publication
(10) Pub. No.: US 2005/0050833 A1
(43) Pub. Date: Mar. 10, 2005

(54) Pet door weather guard

(76) Inventor: David L. Spray, Bruke, VA (US)

Correspondence Address: WEINER &BURT, P.C., 635 N. US-23, P.O. BOX 186, HARRISVILLE, MI, 48740, US

(21) Appl. No.: 10/916,227

(22) Filed: Aug. 11, 2004

Related U.S. Application Data
(60) Provisional application No. 60/501,901, filed on Sep. 10, 2003.

(51) Int. Cl. A01K 1/10

(52) U.S. Cl. 52/716.2

(57) ABSTRACT

A pet door weather guard device to limit the effects of wind, snow, rain, sleet, ice and other weather problems on the operational performance of a pet door. The device provides some limit to snow buildup in front of the pet door, so that pets may enter and exit with less restriction. The device is in the form of a protective cover, which is designed to be secured to a flat surface, such as door or wall, around the frame of a commercially available pet door.

The present patent application claims priority from and is based on U.S. Provisional Patent Application Ser. No. 60/501,901 filed Sep. 10, 2003, the entire contents of which is incorporated herein by reference thereto.

The present invention relates generally to a new and useful device to be used in conjunction with commercially available pet doors.

More particularly, the present invention relates to a novel and unique pet door weather guard device which limits the effects of the weather on the operational performance of a pet door.

### BACKGROUND OF THE INVENTION

Commercially available pet doors are subject to the effects of wind, snow, rain, sleet, ice and other weather problems which adversely effect the operational performance of the pet door.

The relevant art is exemplified by the following U.S. patents: U.S. Pat. No. 4,399,771 issued in 1983 to Medley entitled “PET DOOR”; U.S. Pat. No. 4,408,416 issued in 1983 to Davlantes entitled “PET ACCESS DOOR PANEL”; and U.S. Pat. No. 4,480,407 issued in 1984 to Needham et al. entitled “PET DOORS”.

It is a desideratum of the present invention to avoid the animadversions of the prior art devices, techniques and systems, and to provide a novel and unique pet door weather guard device which limits the effects of wind, snow, rain, sleet, ice and other weather problems on the operational performance of the pet door.

### SUMMARY OF THE INVENTION

The present invention provides a pet door weather guard device, comprising a main structure surrounding at least the top portion and side portions of a pet door; and weather means forming part of said structure whereby said weather means sheds precipitation falling on said pet door and said pet door weather guard device.

The present invention also provides a new and useful pet door weather guard device, comprising: a top member; a pair of side members descending from said top member; flange means for securing at least said pair of side members to an external substantially flat surface around a frame of a pet door; and said top member being provided with weather means for shedding precipitation falling on said top member.

It is a primary object of the present invention to provide a novel and unique pet door weather guard device which limits the effect of the weather on the operational performance of a pet door.

Another object of the present invention is to provide a novel and unique pet door weather guard device which provides some limit to snow buildup in front of the pet door, so that pets may enter and exit with less restriction.

A further object of the present invention is to provide a pet door weather guard device as described hereinabove, which constitutes a protective cover designed to limit the effects of wind, snow, rain, sleet, ice and other weather problems on the operational performance of a pet door.

Yet another object of the present invention is to provide a novel and unique pet door weather guard device as described hereinabove wherein the device comprises a protective cover, including a top with side panels, designed to be secured to a flat surface, such as a door or a wall, around the frame of a commercially available pet door.

Another object of the present invention is to provide a novel and unique pet door weather guard device as described hereinabove, wherein the top member of the guard device is provided with weather means for shedding precipitation falling on said top member.

The present invention possesses many other advantages and features which will become apparent to those persons skilled in this particular area of technology, and to others, when reading the detailed description of one exemplary preferred embodiment of the present invention as set forth hereinbelow in conjunction with the accompanying drawings.

### BRIEF DESCRIPTION OF THE DRAWINGS

FIG. 1 is a perspective illustration of a preferred embodiment of the present invention, and depicting how the pet door weather guard device looks when installed.

FIG. 2 is a top plan view of the pet door weather guard device as depicted in FIG. 1.

FIG. 3 illustrates a side elevational view taken from the left side of the pet door weather guard device shown in FIG. 1.

FIG. 4 is a front elevational view of the pet door weather guard device of FIGS. 1, 2 and 3 which deletes external components for clarity of illustration.

### DETAILED DESCRIPTION OF SOME PREFERRED EMBODIMENTS OF THE PRESENT INVENTION

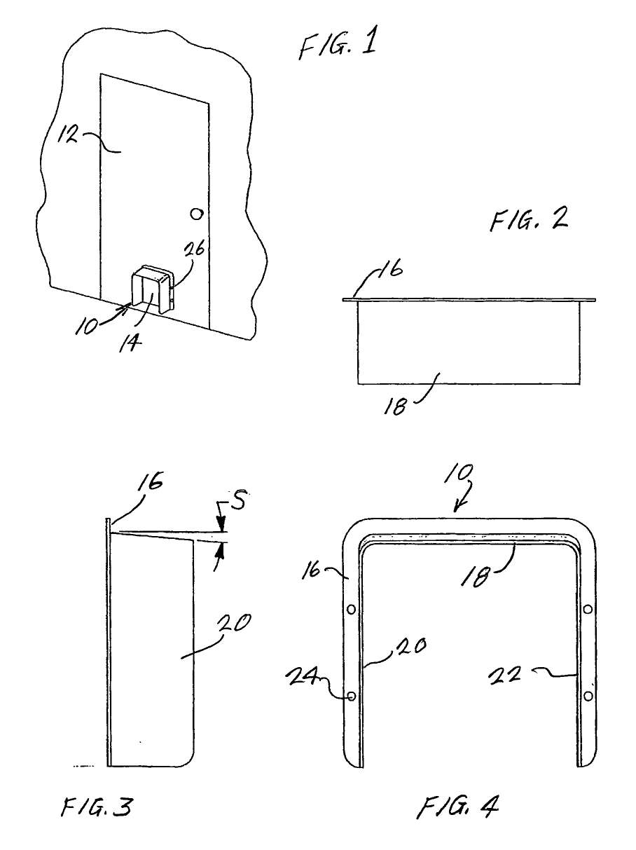

With reference to FIG. 1, there is shown the pet door weather guard device 10 in accordance with the present invention secured to a flat surface 12, such as a door, around the frame of a commercially available pet door 14.

The pet door weather guard device 10 is provided with a flange member 16 which surrounds the top member 18 thereof and the pair of side members 20 and 22 descending from the top member 18.

As best seen in FIGS. 1 and 4, the flange member 16 is provided with a plurality of apertures 24 to accommodate screws 26 or other fastening devices for fastening the guard device 10 to a flat surface 12 such as a door or wall.

With reference to FIGS. 1-4, the novel pet door weather guard device 10 includes a top member 18, a pair of side members 20 and 22 descending from the top member 18, a flange 16 for securing at least the pair of side members 20 and 22 to an externally substantially flat surface 12 around the frame of a pet door 14, and the top member 18 being provided with weather means for shedding precipitation falling on the top member 18.

The weather means is formed by providing the top member 18 with a predetermined slope to shed precipitation therefrom. This predetermined slope, which is designated S in FIG. 3, may preferably, but not necessarily, entail a slope of approximately 5 degrees.

Preferably, but not necessarily, the entire pet door weather guard device 10 may be formed as a unitary structure. The pet door weather guard device may be fabricated from any suitable material, such as plastic, wood, metal, etc., or a combination of the foregoing.

There has been illustrated in the accompanying drawings and described hereinabove only one unique and novel preferred embodiment of the present invention which can be constructed in many different configurations, arrangement of components, sizes and shapes.

It should be understood that many changes, modifications, variations, and other uses and applications of the inventive device will become apparent to those persons skilled in this particular area of technology and to others after having been exposed to the present patent specification and accompanying patent drawings.

Any and all such changes, modifications, variations, and other uses and applications which do not depart from the spirit and scope of the present invention are therefor covered by and embraced within the present invention and the present patent application.

1. A pet door weather guard device, comprising:
a main structure surrounding at least the top portion and side portions of a pet door; and
weather means forming part of said structure whereby said weather means sheds precipitation falling on said pet door and said pet door weather guard device.

2. A pet door weather guard device according to claim 1, wherein:
said main structure includes flange means for securing said main structure to an external substantially flat surface around a frame of said pet door.

3. A pet door weather guard device according to claim 2, wherein:
said flange means is provided with a plurality of apertures for accommodating fastening means for fastening said pet door weather guard device to said external substantially flat surface around said frame of said pet door.

4. A pet door weather guard device according to claim 1, wherein:
said main structure includes a top member and a pair of side members descending from said top member.

5. A pet door weather guard device according to claim 2, wherein:
said main structure includes a top member and a pair of side members descending from said top member.

6. A pet door weather guard device according to claim 3, wherein:
said main structure includes a top member and a pair of side members descending from said top member.

7. A pet door weather guard device according to claim 1, wherein:
said weather means includes a member having a predetermined slope for shedding precipitation therefrom.

8. A pet door weather guard device according to claim 2, wherein:
said weather means includes a member having a predetermined slope for shedding precipitation therefrom.

9. A pet door weather guard device according to claim 3, wherein:
said weather means includes a member having a predetermined slope for shedding precipitation therefrom.

10. A pet door weather guard device according to claim 4, wherein:
said weather means includes a member having a predetermined slope for shedding precipitation therefrom.

11. A pet door weather guard device according to claim 5, wherein:
said weather means includes a member having a predetermined slope for shedding precipitation therefrom.

12. A pet door weather guard device according to claim 6, wherein:
said weather means includes a member having a predetermined slope for shedding precipitation therefrom.

13. A pet door weather guard device according to claim 7, wherein:
said predetermined slope comprises a slope of approximately 5 degrees.

14. A pet door weather guard device according to claim 8, wherein:
said predetermined slope comprises a slope of approximately 5 degrees.

15. A pet door weather guard device according to claim 9, wherein:
said predetermined slope comprises a slope of approximately 5 degrees.

16. A pet door weather guard device according to claim 10, wherein:
said predetermined slope comprises a slope of approximately 5 degrees.

17. A pet door weather guard device according to claim 11, wherein:
said predetermined slope comprises a slope of approximately 5 degrees.

18. A pet door weather guard device according to claim 12, wherein:
said predetermined slope comprises a slope of approximately 5 degrees.

19. A pet door weather guard device according to claim 4, wherein:
said side members are of sufficient dimensions to limit the effects of wind on the operational performance of said pet door.

20. A pet door weather guard device according to claim 5, wherein:
said side members are of sufficient dimensions to limit the effects of wind on the operational performance of said pet door.
